(19) United States
(12) Patent Application Publication
(10) Pub. No.: US 2016/0275019 A1
(43) Pub. Date: Sep. 22, 2016

(54) METHOD AND APPARATUS FOR PROTECTING DYNAMIC LIBRARIES

(71) Applicant: INKA ENTWORKS, INC., Seoul (KR)

(72) Inventors: Jae Min NAM, Seoul (KR); Jung Geun PARK, Gyeonggi-do (KR); Jun Ho HONG, Gyeonggi-do (KR); Jun Seok OH, Seoul (KR); Jung Soo KIM, Seoul (KR)

(21) Appl. No.: 15/027,867

(22) PCT Filed: Oct. 2, 2014
(86) PCT No.: PCT/KR2014/009307

§ 371 Date: Apr. 7, 2016

(30) Foreign Application Priority Data
Oct. 10, 2013 (KR) 10-2013-0120845

(51) Int. Cl. G06F 12/14

(52) U.S. Cl. CPC G06F 12/1408; G06F 2212/1052; H04L 2209/16

(57) ABSTRACT

Disclosed is a method for protecting a dynamic library from the static analyzer.

In a method of protecting a dynamic library, the method may comprise: loading, into a main memory, an application program using the dynamic library; loading a security-responsible dynamic library into the main memory; generating a dynamic library-to-be-protected by decrypting an encrypted dynamic library stored in the security-responsible dynamic library; and calling a specific module included in the dynamic library-to-be-protected by the application program.

### BACKGROUND OF THE INVENTION

1. Field of the Invention

The present invention relates to a method for protecting a dynamic library from an analysis and attack using an analysis tool.

2. Description of the Related Art

It should be noted that the contents described below merely provide only the background information related to embodiments of the invention and do not constitute prior art.

In a program, a library implies complied functions made, in advance, to be reusable. In the program, the reason why the library is used is that a function can be conveniently used when being reused, the detailed implementation of a function can be hidden when the function is distributed in the form of a library, and a pre-compiled function can be used as needed so that maintenance thereof is convenient.

The library is classified into a static library included in an object file of an application program in the process of compiling a program and a dynamic library included in the object file when a computer program is executed. The static library is combined with an object of an application program in a compiling process to form one execution file. In contrast, the dynamic library is made to separate, from an application program, a function commonly required by various programs and load the function into a memory only when being called in run-time. Since the static library is combined with an object of an application program in a compiling process, the size of an execution file is increased as the application program includes a larger number of the static libraries. When a plurality of application programs using the same static library are simultaneously executed, the same respective codes are loaded into a memory, and thus, it is difficult to efficiently use the memory. However, when the dynamic library is used, a plurality of application programs share and use one dynamic library, so that it is possible to efficiently use the memory.

The code of the program, which is required to be protected for its performance of the core function of the program, should be commonly used by a plurality of programs, and thus, is mainly made as dynamic library. In this case, a security for the dynamic library is necessary, and it becomes an issue how to safely execute the dynamic library without exposing the internal information of application program to the outside. In particular, when a static analyzer such as a debugger or an Interactive DisAssembler (IDA) is used, the dynamic library can be analyzed, so that contents thereof can be changed or a new function can be inserted. When a tool such as the IDA is used, a machine code can be analyzed up to the level of source code.

In order to protect the dynamic library from the static analyzer, in the related art, a method was used of encrypting the dynamic library, adding the encrypted dynamic library to a resource of a program, storing the encrypted dynamic library in the resource of the program, decrypting the encrypted dynamic library at a necessary time point, storing the decrypted dynamic library in the form of a file, using the file after loading it into a memory, and deleting the file. The related art for protecting the dynamic library will be described in detail with reference to FIG. 2.

However, the conventional method for protecting the dynamic library can encrypt the dynamic library to prevent the dynamic library from being analyzed by the static analyzer, but since the dynamic library is exposed to the outside, it is easily disclosed that the dynamic library is an important file. Further, when the decrypted dynamic library is leaked, since a decrypting process is incapacitated, there is a problem that when the decrypted dynamic library is loaded, the dynamic library is bypassed only by modifying relatively small codes. As a result, the related art is not a fundamental means which can solve the problem by protecting the dynamic library from the static analyzer.

### SUMMARY OF THE INVENTION

Embodiments of the invention are to provide methods for protecting from a static analyzer a dynamic library performing the core function of a program.

According to one aspect of this embodiment, in a method of protecting a dynamic library, the method may comprise: loading, into a main memory, an application program using the dynamic library; loading a security-responsible dynamic library into the main memory; generating a dynamic library-to-be-protected by decrypting an encrypted dynamic library stored in the security-responsible dynamic library; and calling a specific module included in the dynamic library-to-be-protected by the application program.

According to another aspect of this embodiment, in an apparatus for protecting a dynamic library, the apparatus may comprise: an auxiliary storage device configured to store an application program and the dynamic library; a main memory connected to the auxiliary storage device, wherein the application program and the dynamic library are loaded into the main memory; a dynamic library generating unit configured to generate a dynamic library-to-be-protected by decrypting an encrypted dynamic library stored in a security-responsible dynamic library loaded into the main memory; and a dynamic library calling unit configured to call a specific module included in the dynamic library-to-be-protected by the application program.

As described above, according to embodiments of the invention, a dynamic library is encrypted, thereby safely protecting, from a static analyzer, the dynamic library which is in charge of the core function of a program. According to embodiments of the invention, since the dynamic library-to-be-protected, which is in charge of the core function of a program and is required to be protected, is stored in a security-responsible dynamic library which is in charge of security, the dynamic library-to-be-protected is not exposed to the outside to prevent a program from being attacked, and since the dynamic library-to-be-protected is stored in an encrypted state, it is impossible to analyze the dynamic library-to-be-protected by using the static analyzer, thereby providing the dynamic library-to-be-protected with security. The security-responsible dynamic library includes a security logic. The security logic includes functions which, when the security-responsible dynamic library is loaded into a memory, are automatically executed to detect an attack of an attacker or configure, in advance, an environment such that the attacker cannot perform an attack.

Further, according to an embodiment of the invention, in order to enhance the security between the dynamic library-to-be-protected and the security-responsible dynamic library, the dynamic library-to-be-protected and the security-responsible dynamic library are connected to each other by a separately-made static library, not to allow the dynamic library-to-be-protected to be driven without the security-responsible dynamic library, thereby enhancing the security of the dynamic library-to-be-protected which provides a core function. The security-responsible dynamic library includes a security logic which, for the security of the dynamic library-to-be-protected or the application program, is loaded into a memory and then is automatically executed to perform a security function such as anti-debugging or anti-dump which detects or prevents an attack of an attacker. Even when the dynamic library-to-be-protected is analyzed by the static analyzer, and thus is modified, whether a file is modified can be determined through the integrity verification of the file, and when the file is modified, the execution of the application program can be stopped.

### BRIEF DESCRIPTION OF THE DRAWINGS

The above and other objects, features and advantages of the present invention will be more apparent from the following detailed description taken in conjunction with the accompanying drawings, in which:

FIG. 1 is an exemplary view illustrating a computer device for executing a program including a dynamic library;

FIG. 2 is an exemplary view illustrating a method for protecting a dynamic library;

FIG. 3A is an exemplary view illustrating a state in which an application program and a security-responsible dynamic library are loaded into a main memory according to the present embodiment;

FIG. 3B is an exemplary view illustrating a state in which an application program, a security-responsible dynamic library and a dynamic library-to-be-protected are loaded into a main memory according to the present embodiment;

FIG. 4 is an exemplary view illustrating a connection relationship between an application program and a dynamic library according to the present embodiment;

FIG. 5 is an exemplary view illustrating a state in which an application program, a security-responsible dynamic library, a dynamic library-to-be-protected, a pseudo dynamic library, and a hash registry are loaded into a main memory according to the present embodiment;

FIG. 6 is a flowchart illustrating a process of calling, by an application program, a specific module within a dynamic library-to-be-protected according to the present embodiment;

FIG. 7 is an exemplary view illustrating a process of providing security for protecting a dynamic library from a static analyzer according to the present embodiment; and

FIG. 8 is a block diagram illustrating a device for protecting a dynamic library from a static analyzer according to the present embodiment.

### DETAILED DESCRIPTION OF EMBODIMENTS

Hereinafter, embodiments of the invention will be described in detail with reference to the accompanying drawings.

A system for implementing a method for protecting a dynamic library from a static analyzer according to the present embodiment includes platforms such as Windows, MAC OS, Linux, Unix, IOS, Android, Unity, other Operating Systems (OSs) supporting a dynamic library, and a virtual machine, but is not limited to any one system. Herein, the dynamic library may be referred to as various names such as a dynamic link library, a shared library, a run-time library, an ActiveX control.

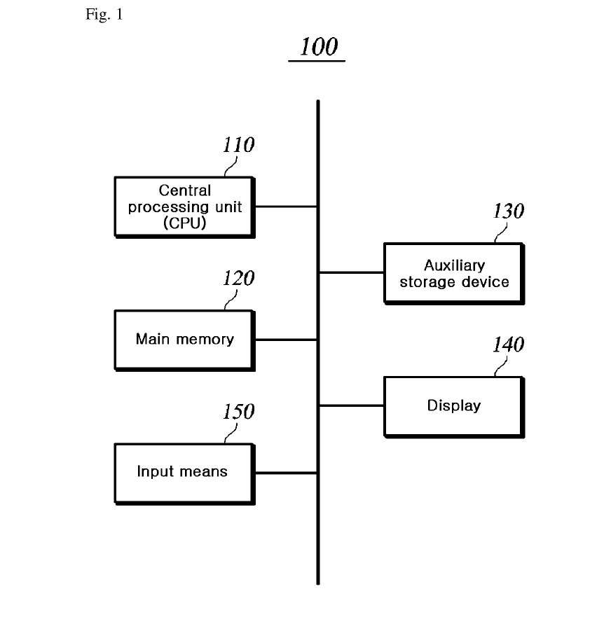

FIG. 1 is an exemplary view illustrating a computer device 100 for executing a program including a dynamic library.

An application program stored in an auxiliary storage device 130 is loaded into a main memory 120, and a central processing device 110 executes the application program. The application program receives data necessary for the execution from an input device 150, and outputs a result of the execution to a display device 140. The application program loaded into the main memory 120 loads a dynamic library required thereby from the auxiliary storage device 130 into the main memory 120 and then uses the loaded dynamic library. At this time, the loaded dynamic library can be used by other application programs running on the main memory 120 as well as by the application program which has loaded the dynamic library into the main memory 120. A plurality of application programs use one dynamic library loaded into the main memory 120, to reduce a physical use of the main memory 120, thereby allowing for efficient memory management. When a patch is required due to occurrence of an error in the dynamic library, the dynamic library has only to be rewritten and distributed regardless of an application program using the dynamic library. When a static library is used, all application programs using the static library should be rewritten and redistributed. Further, when a function included in the dynamic library is required to be changed, the plurality of application programs can be applied without change thereof if only the dynamic library is modified, thereby reducing maintenance costs.

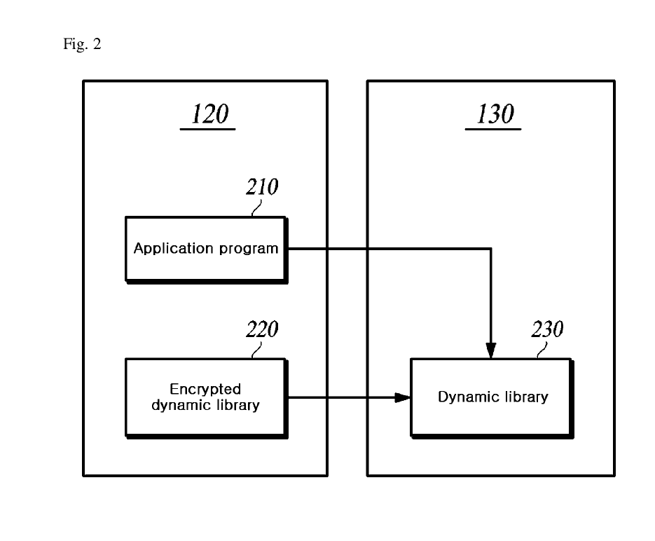

FIG. 2 is an exemplary view illustrating a method for protecting a dynamic library.

An application program 210 and a resource-typed encrypted dynamic library 220 stored in the auxiliary storage device 130 are loaded into the main memory 120. The encrypted dynamic library is a dynamic library-to-be-protected which is in charge of the core function of an application program, and thus is required to be protected. In order to call a specific module included in the dynamic library-to-be-protected by the application program 210 or by a dynamic library which the application program uses, the encrypted dynamic library 220 should be decrypted, a dynamic library 230 should be stored in the auxiliary storage device 130 in the form of a file, and the dynamic library 230 should be loaded into the main memory 120. After the dynamic library-to-be-protected is loaded into the main memory 120, the application program 210 or the dynamic library can call a specific function.

The conventional method of separating a dynamic library from an application program, encrypting the dynamic library, converting the encrypted dynamic library into a resource, storing the resource, and decrypting the encrypted dynamic library when the dynamic library is required by the application program, can prevent the dynamic library from being analyzed by a static analyzer, but the dynamic library may be easily discovered by a person who attempts to maliciously attack a program, and thus, the method alone is insufficient to protect the dynamic library. There is a security problem that when a person who attempts to maliciously attack a program incapacitates a part of an application program, which is in charge of decryption and loads a dynamic library, and modifies and loads a decrypted dynamic library file, then the application program has no choice but to be executed.

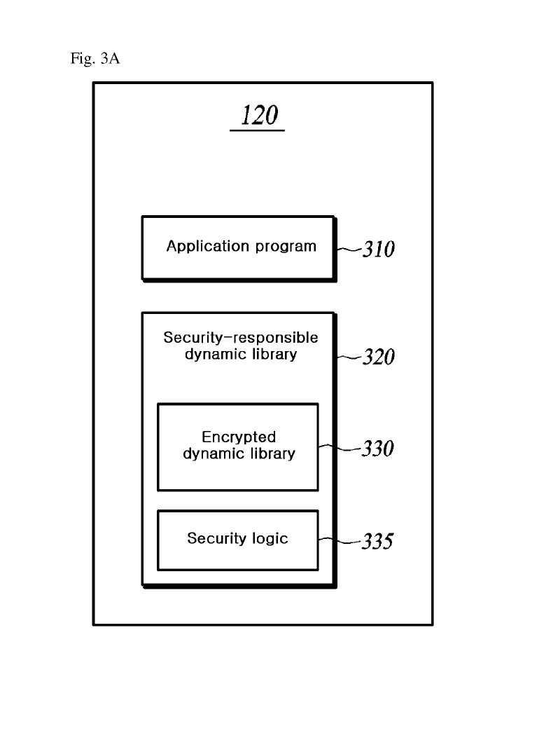

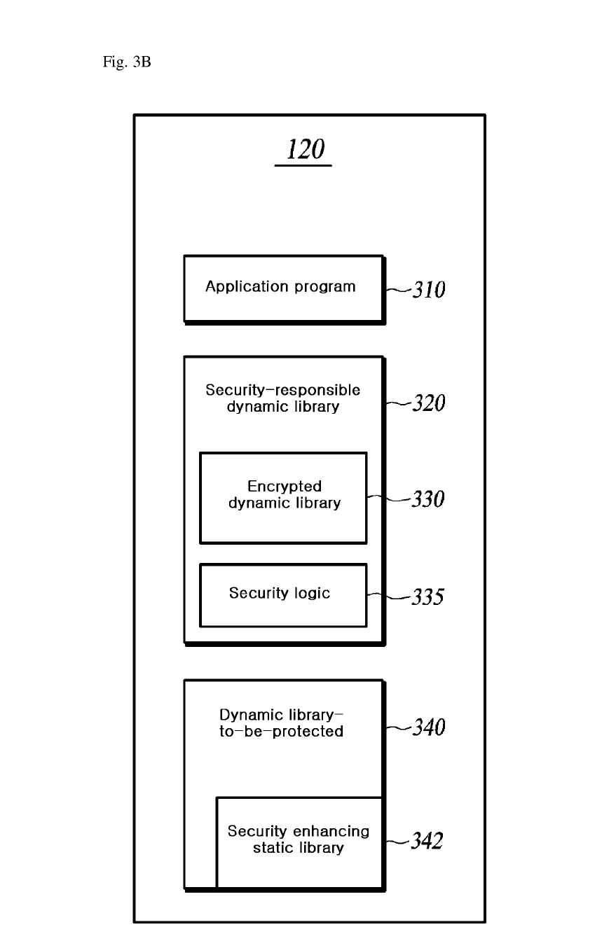

FIG. 3A is an exemplary view illustrating a state in which an application program and a security-responsible dynamic library are loaded into a main memory according to the present embodiment.

When an application program 310 is loaded into the main memory 120 and then is executed, a specific module within the dynamic library-to-be-protected is called. At this time, a security-responsible dynamic library 320 is loaded into the main memory 120. FIG. 3A illustrates a state in which the security-responsible dynamic library 320 stores a dynamic library requiring security in the inside thereof in the form of an encrypted dynamic library 330, and includes a security logic 335 for protecting a program from an external attacker. The dynamic library-to-be-protected is stored in the security-responsible dynamic library 320 in the form of an encrypted dynamic library 330, so that the dynamic library-to-be-protected can be hidden from a person who attempts to maliciously attack or analyze a program by using a static analyzer. Therefore, a problem which occurs in the related art due to the exposure of the dynamic library-to-be-protected to the outside can be resolved. A security logic 335 is automatically executed immediately after the security-responsible dynamic library 320 is loaded into the main memory 120, and then configures, together with anti-debugging and anti-dump, in advance, an environment in which an attack on an application program or a dynamic library can be detected or made impossible.

FIG. 3B is an exemplary view illustrating a state in which an application program, a security-responsible dynamic library and a dynamic library-to-be-protected are loaded into a main memory according to the present embodiment.

FIG. 3B illustrates a state in which, with the application program 310 and the security-responsible dynamic library 320 in FIG. 3A loaded into the main memory 120, the encrypted dynamic library 330 within the security-responsible dynamic library 320 is decrypted, the dynamic library-to-be-protected 340 is stored in the auxiliary storage device 130 in the form of a file, and then the dynamic library-to-be-protected 340 is loaded into the main memory 120. After the dynamic library-to-be-protected 340 is loaded into the main memory 120, the file can be deleted from the auxiliary storage device 130 such that the dynamic library-to-be-protected 340 is not exposed to a person attempting to analyze a program by using the static analyzer.

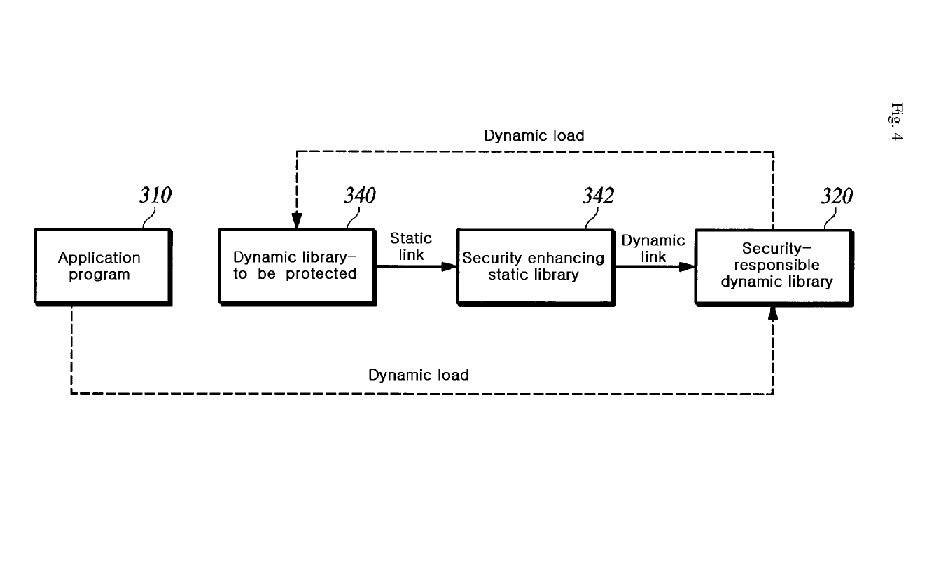

The dynamic library-to-be-protected 340 includes a security enhancing static library 342 in order to further enhance security. The security enhancing static library 342 is made in the form of a static library in advance, and, when the dynamic library-to-be-protected 340 is made, it is statically linked, and, to the security-responsible dynamic library 320, is dynamically linked. In this way, when the libraries are connected to each other, then the dynamic library-to-be-protected 340 calls at least one function within the security enhancing static library 342, and the security enhancing static library 342 calls at least one function within the security-responsible dynamic library 320, so that the dynamic library-to-be-protected 340 cannot be used without the security-responsible dynamic library 320, and thus, the security is further enhanced. FIG. 4 illustrates a connection between libraries.

Further, the security enhancing static library 342 may be made in advance to be used, and thus, a code of the security enhancing static library may be obfuscated, thereby making the reverse engineering analysis using the static analyzer difficult. This prevents the role of the security enhancing static library 342 from being analyzed, to protect the dynamic library-to-be-protected 340 from a person attempting to maliciously analyze a program.

FIG. 4 is an exemplary view illustrating a connection relationship between an application program and a dynamic library according to the present embodiment.

FIG. 3B illustrates an example where the application program 310 and the dynamic library are loaded into the main memory 120, and FIG. 4 illustrate a connection relationship among the application program 310, the dynamic library-to-be-protected 340, the security enhancing static library 342, and the security-responsible dynamic library 320. In order for the application program 310 to call a specific function within the dynamic library-to-be-protected 340, the security-responsible dynamic library 320 is dynamically loaded into the main memory 120, and the security-responsible dynamic library 320 decrypts the encrypted dynamic library stored therein and stores the decrypted dynamic library in the auxiliary storage device 130 in the form of a file.

The application program 310 or the security-responsible dynamic library 320 dynamically loads, into the main memory 120, the dynamic library-to-be-protected 340 stored in the auxiliary storage device 130. At this time, at least one function within the security enhancing static library 342 statically linked in the dynamic library-to-be-protected 340 is called and at least one function within the security-responsible dynamic library 320 is called by the security enhancing static library 342, thus the dynamic library-to-be-protected 340 cannot be used without the security-responsible dynamic library 320. That is, the dynamic library-to-be-protected 340 calls a function within the security enhancing static library 342, and the called function calls the security-responsible dynamic library 320 again, thereby making it possible to identify that the dynamic library-to-be-protected 320 is first loaded into the main memory 120. Since the security-responsible dynamic library 320 performs a function for security immediately after being loaded into the main memory 120, the identifying process serves to guarantee that a security function has been configured.

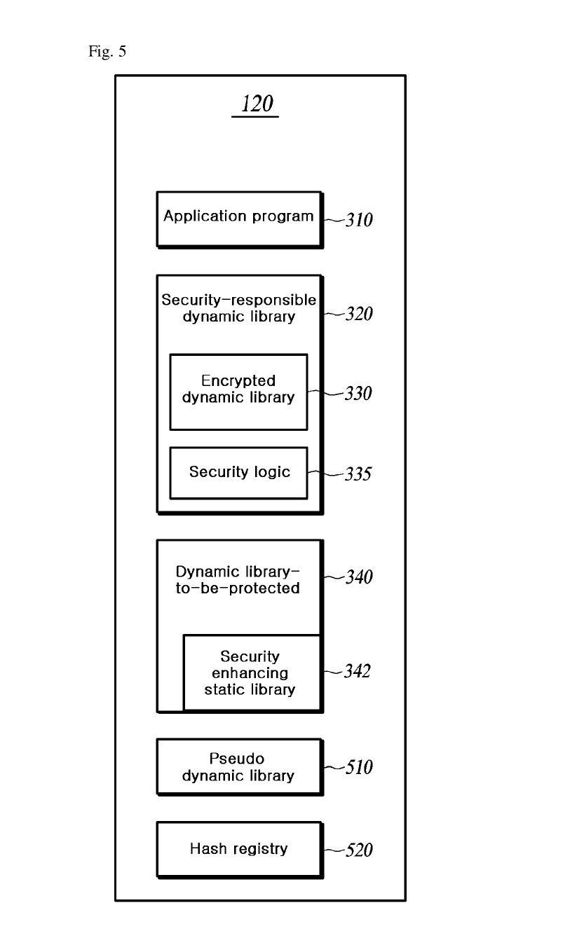

FIG. 5 is an exemplary view illustrating a state in which an application program, a security-responsible dynamic library, a dynamic library-to-be-protected, a pseudo dynamic library, and a hash registry are loaded into a main memory according to the present embodiment.

FIG. 5 illustrates a state in which a pseudo dynamic library 510 and a hash registry 520 are additionally loaded into the main memory 120, while the application program 310, the security-responsible dynamic library 320 and the dynamic library-to-be-protected 340 requiring security are loaded into the main memory 120. The pseudo dynamic library 510 is written with the same name as that of the dynamic library-to-be-protected in order to disguise the fact that the dynamic library-to-be-protected 340 is stored in the security-responsible dynamic library 320 in an encrypted state, from a person attempting to maliciously attack an application program. As a result, the attacker recognizes the pseudo dynamic library 510 as a dynamic library performing the core function of a program. Like the security-responsible dynamic library 320, the pseudo dynamic library 510 may include a security logic, and can obfuscate a code of the pseudo dynamic library 510.

The hash registry 520 includes hash codes per file, which are extracted by inputting, into a hash function, the application program 310, the security-responsible dynamic library 320, the dynamic library-to-be-protected 340 requiring security, the pseudo dynamic library 510, and files used by application programs. Although hash codes for the application program 310, the security-responsible dynamic library 320, and the dynamic library-to-be-protected 340 requiring security are essential, a hash code for the pseudo dynamic library 510, and the like is selectively required only when the pseudo dynamic library 510 and the like is loaded into the main memory. The hash registry 520 may be separately stored and be loaded into the main memory 120 as in the example of FIG. 5, and also may be included and stored in the application program 310 or the dynamic library.

Hereinafter, a method of verifying the integrity of a file will be described. In case that the application program 310 calls a specific function of the dynamic library-to-be-protected 340, if the security-responsible dynamic library 320 is loaded into the main memory 120, then a security function is executed, the dynamic library-to-be-protected is generated and is stored in the auxiliary storage device 130, and the dynamic library-to-be-protected 340, the pseudo dynamic library 510, and the hash registry 520 are loaded into the main memory 120. The file verifying integrity is not limited the security-responsible dynamic library 320 but can be any one of the application program 310, the dynamic library-to-be-protected 340, and the pseudo dynamic library 510. The file subject to integrity verification is not limited to the dynamic library-to-be-protected 340, but can be the application program 310, the security-responsible dynamic library 320, and the pseudo dynamic library 510. Even if the application program is analyzed by the static analyzer, and thus, the modified dynamic library-to-be-protected 340 is loaded into the main memory, but the damage to security can be prevented by verifying the integrity of a file. In order to verify the integrity of a file, a hash code is extracted by inputting, in a hash function (MD5, SHA, Checksum, and the like), a file to be verified, and whether the extracted hash code matches any one of hash codes included in a hash registry is determined, and when it is determined that there is no matching hash code, the execution of the application program 310 is stopped.

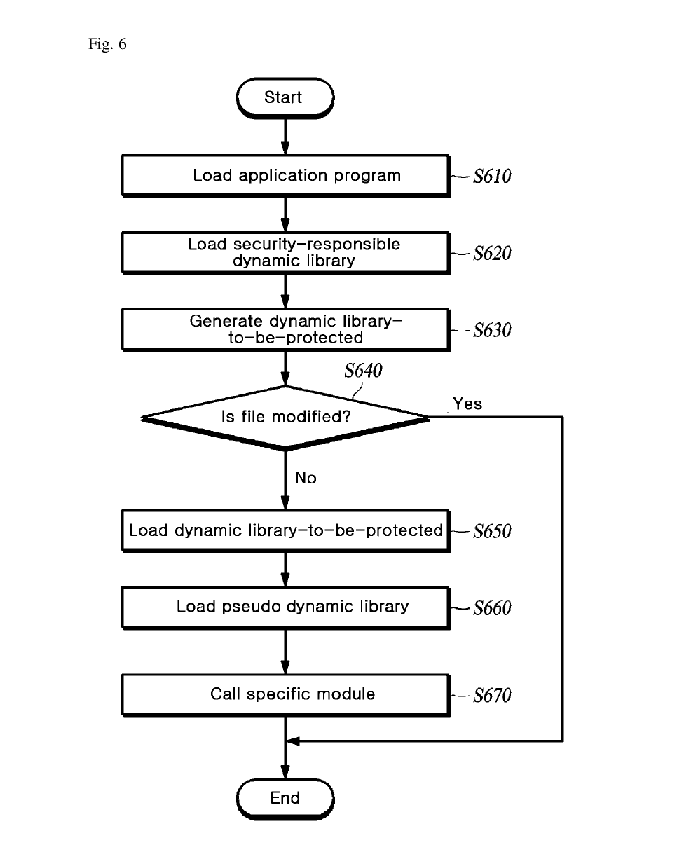

FIG. 6 is a flowchart illustrating a process of calling, by an application program, a specific module within a dynamic library-to-be-protected.

When the application program 310 is executed, the application program 310 is loaded into the main memory 120 (S610). When a specific module within the dynamic library-to-be-protected 340 is called during the execution of the application program 310, the security-responsible dynamic library 320 is firstly loaded from the auxiliary storage device 130 into the main memory 120 (S620), the security function of the security-responsible dynamic library 320 is activated, the dynamic library-to-be-protected 340 is generated (S630) by decrypting the encrypted dynamic library stored in the security-responsible dynamic library 320, and, when the generated dynamic library-to-be-protected 340 is stored in the auxiliary storage device 130 in the form of a file, the integrity of a file of the dynamic library-to-be-protected 340 is verified by the security-responsible dynamic library 320 or the application program 310 (S640). When it is identified in the integrity verification of the file that the file is not modified, the dynamic library-to-be-protected is loaded (S650). When it is identified that the file is modified, the execution of the program is stopped. Further, the pseudo dynamic library 510, which is disguised to be shown as the dynamic library-to-be-protected 340 to a person attempting to maliciously attack a program, is loaded into the main memory 120 (S660). Further, the application program 310 calls a specific module within the dynamic library-to-be-protected 340 (S670), which is in charge of a core function for the execution of the application program.

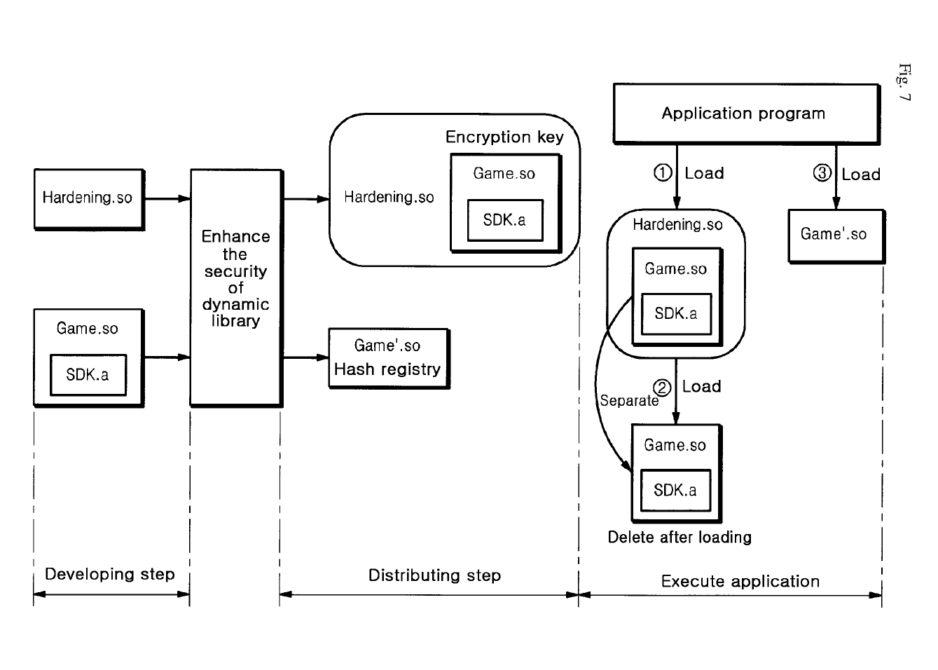

FIG. 7 is an exemplary view illustrating a process of providing security for protecting a dynamic library from a static analyzer.

In a developing step, Hardening.so which is the security-responsible dynamic library 320, Game.so which is the dynamic library-to-be-protected 340, and SDK.a which is the security enhancing static library 342 for enhancing the security between the security-responsible dynamic library 320 and the dynamic library-to-be-protected 340 are developed. Game.so and SDK.a are statically connected to each other, and Game.so includes SDK.a. Through a dynamic library security enhancing step for enhancing the security of these files, Game.so including SDK.a is encrypted and stored in Hardening.so.

An encryption key for decrypting Game.so is stored in Hardening.so. However, the technical concept of the present invention is not limited to storing the encryption key in Hardening.so, but the encryption key may be stored in other places.

In order to hide that a Game.so file is encrypted in Hardening.so, Game′.so, which is the pseudo dynamic library 510 having the same name, is used (Although Game′.so is the same name as Game.so, the two names are differently written for description). An application program and security-applied Hardening.so and Game′.so are distributed to a user.

The user executes the distributed application program, firstly loads Hardening.so into the main memory in order to call a specific module included in Game.so, decrypts Game.so encrypted and stored in Hardening.so, and loads Game.so into the main memory. After Game.so is loaded into the main memory, the Game.so file is deleted, and Game′.so which is a pseudo dynamic library for protecting Game.so is loaded into the main memory.

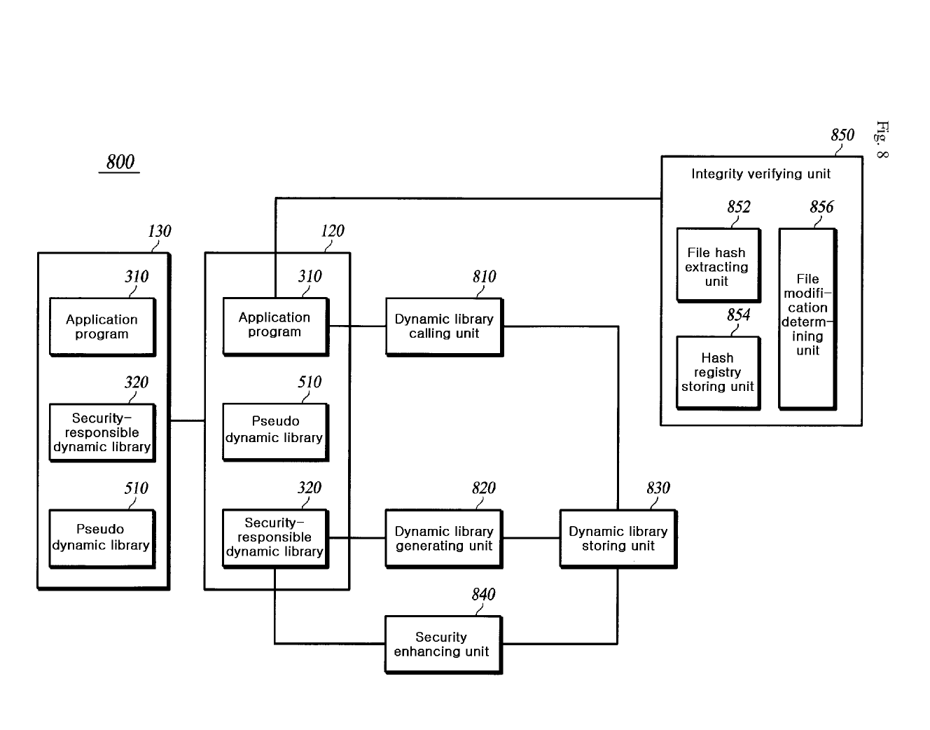

FIG. 8 is a block diagram illustrating a device for protecting a dynamic library from a static analyze according to the present embodiment.

The auxiliary storage device 130 may include files required for the execution of application programs, such as the application program 310, the security-responsible dynamic library 320, and the pseudo dynamic library 510. FIG. 8 illustrates an example where the application program 310, the security-responsible dynamic library 320, and the pseudo dynamic library 510, which are stored in the auxiliary storage device 130, are loaded into the main memory 120. The application program 310 and the security-responsible dynamic library 320 are necessarily included, but the pseudo dynamic library 510 may be selectively included. The application program 310 calls a dynamic library requiring security through a dynamic library calling unit 810. Prior to the calling, a dynamic library generating unit 820 generates the dynamic library-to-be-protected 340 from the security-responsible dynamic library 320, and stores the generated dynamic library-to-be-protected in a dynamic library storage unit 830.

A security enhancing unit 840 is dynamically linked to the dynamic library-to-be-protected stored in the dynamic library storage unit 830 and is statically linked to the security-responsible dynamic library 320, not to allow the dynamic library-to-be-protected 340 to operate without the security-responsible dynamic library 320.

An integrity verifying unit 850 includes a file hash extracting unit 852, a hash registry 854, and a file modification determining unit 856. The file hash extracting unit 852 of the integrity verifying unit 850 extracts hash codes per file by inputting, into a hash function, the application program 310, the security-responsible dynamic library 320, the dynamic library-to-be-protected 340 stored in the dynamic library 830, and files required for the execution of other application programs. Although hash codes for the application program 310, the security-responsible dynamic library 320, and the dynamic library-to-be-protected 340 requiring security are essential, a hash code for the pseudo dynamic library 510, and the like is selectively required only when the pseudo dynamic library 510, and the like is loaded into the main memory. The file modification determining unit 856 determines whether the extracted hash code matches any one of hash codes of the hash registry stored in the hash registry storage unit 854, and when it is determined that there is no matching hash code, stops the execution of the application program.

A device 800 for protecting the dynamic library from the static analyzer according to an embodiment of the invention may be a user terminal such as a personal computer (PC), a notebook computer, a tablet, a personal digital assistant (PDA), a game console, a portable multimedia player (PMP), a playstation portable (PSP), a wireless communication terminal, a smart phone, TV and a media player. The device 800 for protecting the dynamic library from the static analyzer according to an embodiment of the invention may be a server terminal such as an application server and a service server. The device 800 for protecting the dynamic library from the static analyzer according to an embodiment of the invention may respectively refer to various devices provided with (i) a communication device such as a communication modem for performing communication with various devices or a wired/wireless communication network, (ii) a memory for storing data to execute the program, (iii) a microprocessor for performing computation and control by executing the program, and the like. In accordance with at least one embodiment, the memory may be a computer-readable recording/storage medium such as a Random Access Memory (RAM), a Read Only Memory (ROM), a flash memory, an optical disk, a magnetic disk, a solid state disk (SSD). In accordance with at least one embodiment, the microprocessor may be programmed to perform optionally at least one of operations and functions described herein. In accordance with at least one embodiment, the microprocessor may be implemented on the whole or on the part thereof by using hardware such as an application specific integrated circuit (ASIC) of a particular configuration.

The above description is simply to describe the technical concept of the embodiments by way of examples. Those skilled in the art of the embodiments may make various modifications, additions and substitutions, without departing from principles of this disclosure. Accordingly, the embodiments are intended for illustrating rather than for limiting the technical scope of this embodiment. The scope of the technical concept of the embodiments is not limited by the embodiments. The scope of the embodiment is to be interpreted by the following claims. All such modifications and variations are to be construed as being included within the scope of this embodiment.

What is claimed is:

1. A method of protecting a dynamic library, the method comprising:
loading, into a main memory, an application program using the dynamic library;
loading a security-responsible dynamic library into the main memory;
generating a dynamic library-to-be-protected by decrypting an encrypted dynamic library stored in the security-responsible dynamic library; and
calling a specific module included in the dynamic library-to-be-protected by the application program.

2. The method according to claim 1, wherein the generating of the dynamic library-to-be-protected further comprises: storing the dynamic library-to-be-protected in a storage device in the form of a file; and loading the dynamic library-to-be-protected into the main memory.

3. The method according to claim 1, wherein the security-responsible dynamic library is dynamically linked to a security enhancing static library, and the dynamic library-to-be-protected is statically linked to the security enhancing static library.

4. The method according to claim 3, wherein the security enhancing static library calls at least one module within the security-responsible dynamic library.

5. The method according to claim 3, wherein the dynamic library-to-be-protected calls at least one module within the security enhancing static library.

6. The method according to claim 3, wherein the code of the security enhancing static library is obfuscated.

7. The method according to claim 1, wherein the security-responsible dynamic library includes a security logic which detects an attack against the application program or the dynamic library-to-be-protected or configures an environment against the attack, together with anti-debugging or anti-dump.

8. The method according to claim 1, wherein the application program includes a pseudo dynamic library having the same file name as that of the dynamic library-to-be-protected.

9. The method according to claim 1, further comprising generating a hash registry including has codes pef file for files required for the execution of the application program, which essentially include the application program, the security-responsible dynamic library, and the dynamic library-to-be-protected, and selectively includes a pseudo dynamic library subject to whether the pseudo dynamic library is loaded into the main memory

10. The method according to claim 9, further comprising:
verifying the integrity of one of files required for the execution of the application program, by using the hash codes for files required for the execution of the application program; and
when it is determined in the verifying of integrity that one or more files are modified, stopping the execution of the application program.

11. The method according to claim 10, wherein the verifying of integrity is performed by the security-responsible dynamic library.

12. An apparatus for protecting a dynamic library, the apparatus comprising:
an auxiliary storage device configured to store an application program and the dynamic library;
a main memory connected to the auxiliary storage device, wherein the application program and the dynamic library are loaded into the main memory;
a dynamic library generating unit configured to generate a dynamic library-to-be-protected by decrypting an encrypted dynamic library stored in a security-responsible dynamic library loaded into the main memory; and
a dynamic library calling unit configured to call a specific module included in the dynamic library-to-be-protected by the application program.

13. The apparatus according to claim 12, wherein the dynamic library generating unit further includes a dynamic library storage unit configured to store the dynamic library-to-be-protected.

14. The apparatus according to claim 12, further comprising a security enhancing unit configured to dynamically link the security-responsible dynamic library to a security enhancing static library and statically link the dynamic library-to-be-protected to the security enhancing static library.

15. The apparatus according to claim 12, wherein the application program includes a pseudo dynamic library having the same name as that of the dynamic library-to-be-protected.

16. The apparatus according to claim 12, further comprising an integrity verifying unit configured to verify, by using a file hash, the integrity of files required for the execution of the application program, which essentially include the application program, the security-responsible dynamic library and the dynamic library-to-be-protected, and selectively include a pseudo dynamic library subject to whether the pseudo dynamic library is loaded into the main memory.

17. The apparatus according to claim 16, wherein the integrity verifying unit comprises:
a hash registry storing unit configured to store a hash registry including hash codes per file for files required for the execution of the application program;
a file hash extracting unit configured to extract hash codes per file for files required for the execution of the application program; and
a file modification determining unit configured to determine whether the extracted hash code matches any one of hash codes of the hash registry, and, when it is determined that there is no matching hash code, stop the execution of the application program.
